(19) United States
(12) Patent Application Publication
(10) Pub. No.: US 2022/0178807 A1
(43) Pub. Date: Jun. 9, 2022

(54) DEVICE AND METHOD FOR DETECTING A CONCENTRATION OF PREDETERMINED PARTICLES BASED ON THEIR MORPHOLOGICAL PROPERTIES IN AIR

(71) Applicant: ebm-papst neo GmbH & Co. KG, Mulfingen (DE)

(72) Inventors: Ralph WYSTUP, Künzelsau (DE); Frederik WYSTUP, Neuenstein (DE)

(21) Appl. No.: 17/545,272

(22) Filed: Dec. 8, 2021

(30) Foreign Application Priority Data
Dec. 8, 2020 (DE) 102020132574.6

(51) Int. Cl. G01N 15/06; G01N 1/40

(52) U.S. Cl. CPC G01N 15/06; G01N 1/40

(57) ABSTRACT

The present disclosure relates to a device for detecting a concentration of predetermined particles, in particular viruses, in air, which comprises organic and/or inorganic aerosol particles, wherein the device has a supply unit for binding the aerosol particles as particles in a fluid, an imaging unit for producing an enlarged image of the particles contained in the fluid, an image capture unit for capturing and transmitting the image, and an evaluation unit for evaluating the particles depicted in the image, wherein the evaluation unit is designed to automatically detect morphological properties of the particles depicted in the image, to compare the detected morphological properties with morphological properties of the predetermined particles, and by the comparison to determine a proportion of predetermined particles in the image and the concentration of the predetermined particles in the air.

### RELATED APPLICATIONS

The present disclosure claims priority to and the benefit of German Application 10 2020 132 574.6 filed on Dec. 8, 2020, the entire contents of which are incorporated herein by reference.

### TECHNICAL FIELD

The present disclosure relates to a device and an associated method for detecting a concentration of predetermined particles and in particular viruses in air on the basis of their morphological properties and in particular their look or external appearance.

### BACKGROUND

There are a large number of diseases and pathogens and, in particular, disease-causing viruses that are spread via the air and, in particular, via aerosols and are thus present in the air as aerosol particles. Therefore, it is desirable to be able to detect such viruses in the air as well as to determine their concentration in the air and thereby a possible risk of contagion.

In the state of the art, very precise methods for determining the concentration of viruses in the air are known in principle, but these are predominantly based on laboratory methods with correspondingly lengthy analyses, so that the known methods are complex, expensive and, above all, time-consuming. Therefore, the devices used to perform the known methods cannot be used for short-term warning of pathogens, as the results of the analysis would usually simply be available too late.

In addition, the known methods are usually adapted to a single very specific virus or generally to a single specific pathogen and are often not applicable to other pathogens, so that such methods cannot be used to determine the concentration or presence of a wide variety of pathogens in the air.

For an initial assessment of whether pathogens are present in the air, as well as an assessment of the danger posed by the potentially present pathogens, it is initially often not absolutely necessary to know exactly which pathogens or viruses are involved, but only that such pathogens are present with a certain probability and with or in a certain concentration. For this purpose, for example, the as yet unpublished German patent applications with application numbers 10 2020 120 199.0 and 10 2020 124 740.0 propose various solutions by which the presence of particles with a certain particle size can be determined, which are overwhelmingly likely to be certain pathogens.

It should be noted that an aerosol is a heterogeneous mixture (dispersion) of solid and/or liquid suspended particles in a gas, e.g. air.

The suspended particles are called aerosol particles, wherein such aerosol particles can be, for example, dust, pollen, spores, bacteria or viruses, so that a simple measurement of the aerosol particles and thus an estimation of whether pathogens are present is not readily possible.

In particular, when determining the concentration of particles in the air on the basis of the size of the particles, it can therefore happen that particles are included in the determination of the concentration which happen to have a similar size and which do not correspond to the pathogen sought, so that the concentration determined is incorrect.

### SUMMARY

It is therefore the object of the disclosure to overcome the aforementioned disadvantages and to provide a device and an associated method by means of which the concentration of certain particles and, in particular, certain viruses in the air can be determined quickly and with high accuracy.

This object is solved by the combination of features according to patent claim 1.

According to the disclosure, a device for detecting a concentration of predetermined particles, in particular viruses, in air is therefore proposed. The air comprises organic and/or inorganic aerosol particles. The device has a supply unit, an imaging unit, an image capture unit, and an evaluation unit. The supply unit is designed to bind the aerosol particles contained in the air in a fluid, so that the fluid contains the aerosol particles previously contained in the air as particles. The fluid is preferably a liquid, wherein the fluid can also be a gas mixture. It is further provided that the supply unit is designed to provide a steady or uniformly timed fluid flow along a predetermined flow path, wherein the fluid flow, both in the case of a steady and timed supply, can be conveyed continuously along the flow path. Preferably, the supply unit is fluidically connected to the imaging unit with respect to the flow path, so that the fluid or liquid can flow along the flow path from the supply unit into and through the imaging unit. The imaging unit has a correspondingly steady or timed sample channel through which the fluid flow can pass and which determines the predetermined flow path within the imaging unit. Furthermore, the imaging unit is designed to produce a magnified image of the particles contained in the fluid flowing through the sample channel. In both a steady and timed conveying, a fluid containing the particles is present in the imaging unit, so that “in-situ measurement” or “in-situ analysis” can be carried out by enlarging the particles, in which the sample formed by the fluid flowing through the sample channel can therefore change continuously. In particular, there is no need to manually replace or adjust the sample, a sample carrier or other components of the device. To enable fast and automatic analysis and evaluation of the images obtained by the imaging unit, the image capture unit is designed to capture the image, in particular by image technology, and to transmit the image in its captured form to the evaluation unit. Accordingly, the evaluation unit is adapted to automatically detect morphological properties of the particles imaged in the image, to compare the detected morphological properties with morphological properties of the predetermined particles, and to determine a proportion of predetermined particles in the image and the concentration of the predetermined particles in the air by the comparison. Morphological properties is understood to mean in particular the appearance of the particles or viruses, so that the predetermined particles can be distinguished or differentiated from other particles on the basis of their exterior. For example, the concentration may be the number of predetermined particles per predetermined volume of air, such as per cubic meter.

Based on the concentration of the predetermined particles (viruses) in the sample or in the fluid and the concentration of the predetermined particles (viruses) determined therefrom in the air from which the sample was obtained, the evaluation unit can also determine whether certain particles (viruses) are basically present, how high a risk of contagion is and whether the risk of contagion exceeds a predetermined threshold value.

In addition to the concentration of the predetermined particles, concentrations of other particles can also be detected. For example, also several predetermined particles can be provided, in which a first predetermined particle corresponds, for example, to a first virus or first pathogen and a second predetermined particle corresponds, for example, to a second virus or second pathogen, so that it can be determined by means of the evaluation unit which concentrations of the first predetermined particle and the second predetermined particle are present. For this purpose, the morphological properties of both predetermined particles or, in the case of several predetermined particles, of all predetermined particles are known in advance and stored in the evaluation unit. In addition to pathogens or the like, the evaluation unit can be used to also be used, for example, to determine the concentration of dust in the air, since dust is also merely particles in the air.

Based on this, an alarm can also be triggered or a signal can be transmitted to signaling-connected systems, through which or through that a concentration is to be transmitted and, if necessary, a warning of a risk of infection is to be given.

As described in the introduction, although methods and associated devices are known in principle by which viruses or particles can be detected in a sample taken from the air, these can usually only be carried out under laboratory conditions and by specialist personnel and are not suitable for continuous monitoring and checking of the air, in particular room air. Therefore, the basic inventive idea is to provide through the device a means by which a continuous or continuously timed sample stream (fluid stream) can be continuously analyzed to detect and at least indicate the concentration of viruses (particles) in the (room) air.

On the inlet side of the supply unit, the air can be supplied at a predetermined volume flow, for example, by a suction device and in particular sucked in by a fan or blower.

In order to be able to draw conclusions about the concentration of the predetermined particles in the air, it is also preferably provided that the supply unit is designed to bind the aerosol particles contained in a predetermined volume of the air in a predetermined volume of the fluid, so that the concentration of the predetermined particles in the predetermined volume of air can be determined from the proportion of predetermined particles in the predetermined volume of the fluid. It is therefore true that predetermined particles preferably contained in a defined volume of air are present in the fluid after binding in a defined and known volume of fluid.

However, the predetermined particles may be present in very low concentration in the fluid, so that the solution of fluid and particles may be very “thin”. To determine the concentration in a certain section of the sample, i.e. in a specific section of the fluid flowing through the sample channel, and thus simplify the evaluation, it can also be provided that the fluid or liquid is an electrolyte solution, i.e. contains an electrolyte, and the supply unit and/or the imaging unit has an electric field-generating isotachiophoresis device. The isotachiophoresis device is designed to separate the particles bound in the electrolyte solution from each other in sections by their different ionic mobilities, so that the fluid liquid flowing through the sample channel has sections in which particles with the same ionic mobility are concentrated. Thus, there is a section in the sample in which the predetermined particles are present in a higher concentration than in the surrounding sections of the fluid, and in which essentially all predetermined particles of the sample are present, since they have an identical ion mobility. Before and after this section, there are correspondingly other sections in which other particles with different ionic mobilities contained in the sample are present in increased concentration. The imaging unit can be used to selectively enlarge the section of the sample with the increased concentration of the predetermined or substantially the entire sample can be enlarged. For this purpose, the isotachiophoresis device can also have two voltage clamps, of which a first clamp is arranged fluidically on the inlet side of the imaging unit and a second clamp is arranged fluidically on the outlet side of the imaging unit, through which the fluid within the sample channel can be subjected to voltage or an electric field.

In order to be able to drive the fluid flow from the supply unit through the sample channel, a further design variant provides that the device further comprises a pump which is designed to drive the fluid flow along the flow path and to pump or convey the liquid or fluid from the supply unit through the imaging unit with a preferably steady volumetric flow or timed in a continuous cycle.

In order to improve the visibility of the predetermined particles or all particles in the sample or the fluid flowing through the sample channel, it is also preferably provided that the supply unit is designed to admix a contrast medium to the fluid and preferably to the liquid, by means of which, in particular, negative contrasting can be realized, so that the particles or the form and outer appearance of the particles are more visible or recognizable in the image produced by the imaging unit. The contrast medium can in particular be phosphotungstic acid.

The analysis or evaluation of the sample can be further simplified by the fact that fewer particles are present in the sample which are not to be detected anyway, i.e. which deviate from the predetermined particle. For this purpose, it can be advantageously provided that the supply unit has a prefilter on the inlet side, which is designed to filter air flowing into the supply unit on the inlet side, so that organic and/or inorganic aerosol particles contained in the air, which are not the predetermined particles, are at least partially filtered out before the aerosol particles are bound in the fluid, so that they are correspondingly not present in the fluid. Since the most important types of predetermined particles are smaller than 300 nm in diameter, a size filter is particularly suitable as a prefilter, by which essentially all particles with a diameter larger than 300 nm are filtered out.

The prefilter can also have several filters, which can also be based on different filter principles. For example, the prefilter may include a size filter through which preferably substantially all aerosol particles having a diameter greater than the diameter of the predetermined particles are filtered out, so that filtered air is obtained which accordingly preferably contains only aerosol particles with a diameter equal to and/or smaller than the diameter of the predetermined particles. It follows that when the aerosol particles contained in the air are bound in the liquid or fluid, the liquid or fluid contains as particles the aerosol particles previously contained in the filtered air with a diameter equal to or smaller than the diameter of the predetermined particle.

Passing the air into the size filter subsequently results in a more accurate determination of concentration, since less “interfering” particles are present which can falsify the measurement results. Such a size filter may further comprise a plurality of filters arranged in series, such that the size filter may be essentially a filter arrangement through which particles having a diameter greater than the diameter of the predetermined particles may be successively filtered before the remaining particles are bound in the fluid.

Since charged and/or uncharged particles are present in the air, their concentration should preferably not be determined depending on the pathogen to be detected (predetermined particle or virus), a further advantageous variant provides that the prefilter comprises a charge filter through which aerosol particles having a positive charge and/or aerosol particles having a negative charge and/or aerosol particles which are uncharged are filtered out of the air, so that filtered air is obtained which preferably correspondingly only contains aerosol particles that have a predetermined charge corresponding to a by charge of the predetermined particles. Here, charge can be understood as a positive charge, a negative charge as well as no charge. It follows that when the aerosol particles contained in the air are bound in the fluid, the fluid contains essentially only the aerosol particles previously contained in the filtered air with a predetermined charge as particles, which can be realized, for example, by a linear mass spectrometer with quadruple electrodes.

To realize such a charge filter, for example, an electric field can be used, by which the charged (aerosol) particles are deflected from their trajectory and thus removed from the air stream. Furthermore, a charge filter realized in this way can be combined with one or more size filters.

It is also possible for the prefilter to have or provide an inhomogeneous electric field through which polarizable aerosol particles are polarized. Furthermore, the inhomogeneous electric field or a device generating this field is designed to guide the polarized aerosol particles by the inhomogeneous course of the electric field onto a collecting device or to deflect them from their path of movement and to collect them at the collecting device. Accordingly, the polarized aerosol particles collect on or at the collection device and are bound to or from it when the aerosol particles contained in the air are bound in the fluid.

For example, the collecting device may be the condenser of the supply unit, discussed later, and may be appropriately tempered so that the polarized aerosol particles condense on the collecting device. Conducting the air through the inhomogeneous electric field, which accordingly essentially involves filtering and collecting the polarizable particles from the air can be combined with an upstream charge filter and one or more upstream size filters.

If the predetermined particles are non-polarizable but have a pre-known charge, the collecting device can also be designed as a correspondingly oppositely charged surface that attracts the predetermined particles and the pre-known charge. Such correspondingly oppositely charged surfaces intended as a collecting device may also be heated.

For binding the particles in the fluid, it is preferably provided that the supply unit comprises a condenser for binding the aerosol particles contained in the air in the fluid or liquid by condensation. The air with the particles it contains can therefore condense on the condenser to form a condensate (condensation water) and be discharged from it. For this purpose, the condenser can be temperature-controlled, leading to the formation of condensation water, and can be designed, for example, as a Peltier element.

Particularly advantageously, the imaging unit may be a transmission electron microscope (TEM), which has an electron source generating an electron beam, a plurality of magnets directing the electron beam and acting as a lens for the electron beam, and a vacuum chamber through which the electron beam passes. To enlarge the particles contained in the sample, the sample channel preferably passes through the vacuum chamber orthogonally to the electron beam or to a longitudinal axis of the electron beam, and the electron beam passes through the sample channel and the fluid flowing through the sample channel, in particular continuously.

If a TEM is used, the sample channel should be transparent or almost completely permeable to the electron beam generated by the TEM, so that an advantageous variant provides that the sample channel is formed of silicon nitride or another material permeable to the electron beam or to the electrons of the electron beam.

Furthermore, the sample channel may consist of one, two or more membrane(s) abutting each other and forming a channel between them.

Further, the sample channel is preferably selected with respect to its thickness parallel to the electron beam so that the most accurate and sharp imaging or enlarging can be produced by the TEM.

Compared to a conventional TEM, the TEM proposed here can be advantageously designed in that it is specially constructed for enlarging a constantly changing but similar sample at a previously known and unchangeable position, for the change of which, however, no exchange of a sample carrier or the like is necessary. Thus, the TEM proposed according to the advantageous variant does not have to be designed to be substantially focusable or generally adjustable and also does not have to take into account or enable a change of a slide for the samples. Accordingly, it is further preferably provided that the magnets are designed as permanent magnets or as electromagnets and are supplied with a constant or invariable voltage so that the electron beam is directed by the magnets in a single predetermined manner and focused on the fluid flowing through the sample channel. Alternatively, the magnets can also be provided in the form of coils. Furthermore, these are in particular arranged as ring magnets around the vacuum chamber. If electromagnets are provided with a constant voltage, there is no need for complex voltage regulation and a corresponding control system. In addition, a TEM usually comprises several magnets or magnet network systems formed by them, so that, for example, depending on the required magnetic field, first magnets of the TEM can be designed as permanent magnets and second magnets of the TEM as electromagnets supplied with a constant voltage. If the TEM includes an aperture, this can also be designed to be invariant or fixed. The electron source can also be designed to produce an invariable or fixed electron beam with constant predetermined properties.

As described, the proposed TEM is preferably not substantially adjustable. However, it may be envisaged that the TEM or the individual components of the TEM are adjustable within a narrowly defined and predetermined range to allow fine tuning, focusing of the generated image and compensation for aging phenomena. For this purpose, for example, the magnets can be interchangeable or any aperture may be adjustable to a very limited extent.

In addition, the sample channel can be permanently and, in particular, stationarily connected to the vacuum chamber with respect to the vacuum chamber. It is also advantageous to have a one-piece design of vacuum chamber and sample channel with each other, in which they are inseparably connected.

Furthermore, in this particular variant, the vacuum chamber of the TEM does not have to be designed to repeatedly build up a high vacuum. Therefore, the vacuum chamber can be completely sealed in a pressure-tight manner and can further be designed to permanently maintain a vacuum prevailing therein, so that a pressure reduction determining the vacuum only needs to be carried out once and is subsequently maintained permanently, i.e. preferably over the entire service life of the device.

For capturing and in particular digitizing the generated image, the image capture unit is preferably a CCD sensor or a camera. The camera or CCD sensor is designed to capture the image produced by the imaging unit.

Furthermore, the image capture unit can transmit the image captured in this way electronically or by signal to the evaluation unit. Here, both a still image and a moving image, such as a continuous video signal, can be transmitted to the evaluation unit.

For the analysis or evaluation of the transmitted image, the evaluation unit has, according to an advantageous design, a data memory in which the morphological properties and, in particular, an appearance of the predetermined particles are stored, for example by an algorithm, in tabular form or as a comparison image. In addition, the evaluation unit is designed to determine, by means of image processing and object recognition and for example by means of neural networks or artificial intelligence, how many of the particles depicted in the image have morphological properties and in particular an appearance corresponding to the morphological properties and in particular the appearance of the predetermined particles and are thus predetermined particles. If the number of particles in the sample which are the predetermined particles has been determined in this way, their proportion or their number in the sample or in the air can be determined via the number.

Another aspect of the disclosure relates to a method for detecting a concentration of predetermined particles, in particular viruses, in air, which comprises organic and/or inorganic aerosol particles, with a device according to the disclosure. It is envisaged that the aerosol particles contained in the air are bound in a fluid with the supply unit, so that the fluid contains the aerosol particles previously contained in the air as particles as particles, and that a steady or uniformly timed fluid flow is subsequently provided along a predetermined flow path. The imaging unit then generates a magnified image of the particles contained in the fluid flowing through the sample channel. The image thus generated is captured by the image capture unit and transmitted to the evaluation unit. The evaluation unit automatically detects morphological properties of the particles depicted in the image, and then compares the detected morphological properties with morphological properties of the predetermined particles. The comparison determines a proportion of predetermined particles in the image and the concentration of the predetermined particles in the air. The capturing of the morphological properties of the particles and the subsequent comparison is also understood to mean, in particular, a comparison of the image or images of the particles shown thereon generated by the imaging unit with comparison images of the predetermined particles.

Moreover, another aspect of the disclosure relates to a system for detecting a movement and concentration of predetermined particles in a space in terms of a room. The system comprises a central evaluation unit and a plurality of devices according to the disclosure. The devices are distributed in the space according to a predetermined pattern and, in particular, according to a predetermined grid. The central evaluation unit, which can also comprise or form an integral part of the evaluation unit of the devices, is designed to determine and/or predict a concentration of the particles in the space and/or a distribution of the predetermined particles in the space and/or a movement of the predetermined particles in the space from the concentrations determined by the devices in each case. For this purpose, the concentrations can also be determined and observed or analyzed over a longer period of time. For the determination of the concentrations of the movements and the expected, i.e. future, behavior, in particular neural networks, artificial intelligence or extrapolation can also be used.

As the movement of the predetermined particles, not only the macroscopical movement in a space, but also a Brownian molecular movement of the particles can be detected if the devices are suitably arranged.

In addition to an alarm, which can be triggered when the concentration exceeds a limit value, an alarm or signal can also be generated when the predetermined particles in space, i.e. the aerosol cloud moves in a certain direction or to a certain position.

The features disclosed above can be combined in any way, as far as this is technically possible and they do not contradict each other.

### BRIEF DESCRIPTION OF THE DRAWINGS

Other advantageous developments of the disclosure are indicated in the subclaims or are illustrated in more detail below together with the description of the preferred embodiment of the disclosure with reference to the figures. Shown are:

FIG. 1 a device with a TEM as imaging unit.

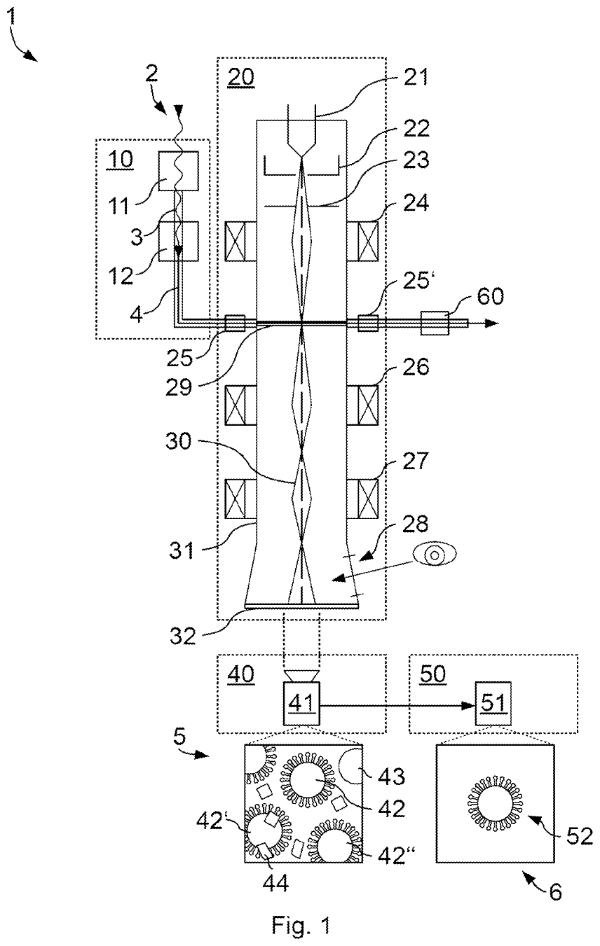

### DETAILED DESCRIPTION OF THE DRAWINGS

The figure is exemplary schematic and shows a device 1 that uses a transmission electron microscope (TEM) as imaging unit 20.

The basic principle of the device 1 is to draw in or take in air 3 and, for example, room air at an air inlet 2, to bind the particles contained in the air 3 in the supply unit 10 in a liquid 4 as a fluid, and to provide a continuous liquid or fluid flow by the imaging unit 20, so that an “in situ analysis” of the particles bound in the liquid 4 is made possible, in which the sample to be analyzed, which is the liquid 4 or, more precisely, the liquid 4 flowing through the imaging unit 20, changes constantly. Together with the liquid 4, a continuous flow of particles is thus provided by the TEM or by the imaging unit 20, through which the particles are imaged enlarged so that the particles contained in the sample or in the liquid 4 can subsequently be analyzed.

In the present case, the supply unit 10 has a prefilter 11 through which particles are filtered out of the air 3 which, due to their size, charge or other factors, cannot be the predetermined particles. The prefilter 11 can have several filter stages for this purpose and use different filter principles.

The air 3 filtered by the prefilter 11 is then condensed by a condenser 12 to form a condensate as a liquid 4 in which the particles previously contained in the filtered air 3 are bound.

The condensate or liquid 4 is then pumped along a predetermined flow path from the supply unit 10 into or through the imaging unit 20, using a pump 60 arranged on the outlet side of the imaging unit 20.

In the liquid 4, the predetermined particles as well as all particles contained therein are initially relatively evenly distributed, so that the searched or predetermined particles, whose concentration is to be determined in the air, are evenly distributed over a section of the liquid 4 and are difficult or costly to find. To improve and simplify the analysis, the imaging unit 20 has an isotachiophoresis device with a first voltage clamp 25 and a second voltage clamp 25′. The first voltage clamp 25 is arranged fluidically on the inlet side of the imaging unit 20 or of the sample channel 29, and the second voltage clamp 25′ is arranged fluidically on the outlet side of the imaging unit 20 or of the sample channel 29, respectively, wherein these establish an electric field in the sample channel 29, so that several sections are formed in the liquid 4 flowing through the sample channel 29, which each have particles with the same or approximately the same ion mobility. In one of these sections, therefore, essentially all particles with an ion mobility equal to the ion mobility of the predetermined particles and thus essentially all predetermined particles are present, so that it is sufficient to image only this section with the imaging unit 20, to detect it with the image capture unit 40 or to evaluate it with the evaluation unit 50.

The imaging unit 20 realized as a TEM in the present case does not have to be designed for different measuring methods or an exchange of sample carriers or the like, so that the TEM is specialized for the present application. For this purpose, the TEM has a completely and permanently sealed vacuum chamber 31 in which a vacuum (high vacuum) has been generated once and is maintained permanently. An electron beam 30 is emitted into the vacuum chamber, which can also be referred to as a measuring column, by an electron source 21 and passes through the vacuum chamber 31 lengthwise. The electron beam 30 is invariably adjusted in its beam strength by a Wehnelt cylinder 22 and is directed or focused by a fixed and non-adjustable aperture 23 and several magnets 24, 26, 27 onto the sample channel 29 and the luminescent screen 32. A first magnet 24 or a first magnet system, which can also consist of a plurality of magnets, serves as a condenser magnet system, a second magnet 26 or a second magnet system, serves as an object magnet system and a third magnet 27 or a third magnet system, respectively, serves as a projection magnet system, wherein these are each designed as permanent magnets and thus invariable.

The liquid 4 flowing through the sample channel 29 is thus always struck by the electron beam 30 in a single predetermined manner and an image of the particles present in the liquid 4 is projected onto the illuminated screen 32 so that an analogous image is visible there, which can also be viewed through the control window 28.

The image projected onto the illuminated screen 32 is captured by the image capture unit 40, which in the present case is essentially formed by a camera 41, and the image is thereby digitized and subsequently transmitted to the evaluation unit 50.

As an example, a section 5 of an image captured by the camera 41 is shown, in which a large number of particles are visible. In particular, four predetermined particles 42, 42′, 42″ are shown there by way of example, which are only partially visible or hidden. These can also be overlaid by other particles 43, 44. Further, the external appearance 52 of a predetermined particle is stored in the evaluation unit 50 or its data memory 51 as a comparative image 6 or as a morphological property of the predetermined particle. With the aid of image processing, the particles in the section 5 of the image are now compared with the external appearance 52 of the target particle or the predetermined particle. If the match with the comparison image 6 is sufficiently high, the respective analyzed particle in the cutout 5 is recognized and counted as a predetermined particle. The predetermined particles or viruses can thus be distinguished from other particles by their external appearance or form. For example, although the particle 43 has an approximately identical size, so that it would be incorrectly identified as a virus or predetermined particle if it were determined on the basis of size, it has a completely different contour or surface shape, so that it can be correctly classified as not being a predetermined particle or virus with the presently proposed device.

1. Device for detecting a concentration of predetermined particles, including viruses, in air, which comprises organic and/or inorganic aerosol particles, the device comprising:
a supply unit, an imaging unit, an image capture unit, and an evaluation unit;
wherein the supply unit is configured to bind the aerosol particles contained in the air in a fluid such that that the fluid contains the aerosol particles previously contained in the air as particles, and is configured to provide a steady or uniformly timed fluid flow along a predetermined flow path,
wherein the imaging unit has a sample channel through which the fluid flow can flow, which determines the predetermined flow path within the imaging unit, and wherein the imaging unit is configured to produce an enlarged image of the particles contained in the fluid flowing through the sample channel,
wherein the image capture unit is configured to capture the image and transmit it to the evaluation unit,
wherein the evaluation unit is configured to automatically detect morphological properties of the particles depicted in the image, and configured to compare the morphological properties detected with morphological properties of the predetermined particles, and by the comparison to determine a proportion of predetermined particles in the image and the concentration of the predetermined particles in the air.

2. Device according to claim 1,
wherein the supply unit is configured to bind the aerosol particles contained in a predetermined volume of the air in a predetermined volume of the fluid, so that the concentration of the predetermined particles in the predetermined volume of the fluid can be determined from the proportion of predetermined particles in the predetermined volume of air.

3. Device according to claim 1,
wherein the fluid is an electrolyte solution, and
wherein the supply unit and/or the imaging unit comprises an electric field generating isotachiophoresis device which is configured to separate the particles bound in the electrolyte solution from one another in sections by their different ionic mobilities, so that the fluid flowing through the sample channel is separated in sections in which particles with the same ionic mobility are concentrated.

4. Device according to claim 1,
further comprising a pump configured to drive the fluid flow along the flow path and to pump the fluid from the supply unit through the imaging unit at a steady volumetric flow or timed in a continuous cycle.

5. Device according to claim 1,
wherein the supply unit is configured to admix a contrast medium to the fluid.

6. Device according to claim 1,
wherein the supply unit has a prefilter on an inlet side, which is configured to filter air flowing into the supply unit on the inlet side, so that organic and/or inorganic aerosol particles contained in the air, which are not the predetermined particles, are filtered out before the aerosol particles are bound in the fluid.

7. Device according to claim 1,
wherein the supply unit comprises a condenser for binding the aerosol particles contained in the air in the fluid by condensation.

8. Device according to claim 1,
wherein the imaging unit is a transmission electron microscope comprising an electron source generating an electron beam, a plurality of magnets directing the electron beam and acting as a lens for the electron beam, and a vacuum chamber through which the electron beam passes, and
wherein the sample channel passes through the vacuum chamber orthogonally to the electron beam and the electron beam passes through the sample channel and the fluid flowing through the sample channel.

9. Device according to claim 8,
wherein the sample channel is formed of a material permeable to the electron beam.

10. Device according to claim 8,
wherein the magnets are configured as permanent magnets or are configured as electromagnets and are supplied with a constant voltage so that the electron beam is directed by the magnets in a single predetermined manner and is focused on the fluid flowing through the sample channel,
and/or wherein the sample channel is permanently connected to the vacuum chamber,
and/or wherein the vacuum chamber is completely sealed in a pressure-tight manner and is configured to permanently maintain a vacuum prevailing therein, so that a pressure reduction determining the vacuum only has to be carried out once.

11. Device according to claim 1,
wherein the image capture unit is a CCD sensor or a camera which is configured to capture the image produced by the imaging unit.

12. Device according to claim 1,
wherein the evaluation unit has a data memory in which the morphological properties and an appearance of the predetermined particles are stored, and the evaluation unit is configured to determine, by image processing and object recognition, how many of the particles depicted in the image have morphological properties and an appearance corresponding to the morphological properties and the appearance of the predetermined particles and are thus predetermined particles.

13. Method for detecting a concentration of predetermined particles, including viruses, in air, which comprises organic and/or inorganic aerosol particles, using a device according to claim 1.

14. System for detecting a movement and concentration of predetermined particles in a space comprising a central evaluation unit and a plurality of devices according to claim 1,
wherein the devices are distributed in the space according to a predetermined pattern having a predetermined grid,
wherein the central evaluation unit is configured to determine and/or predict a concentration of the particles in the space and/or a distribution of the predetermined particles in the space and/or a movement of the predetermined particles in the space from the concentrations determined in each case by the devices.

15. Device according to claim 8, wherein the sample channel is formed of silicon nitride.
